(19) United States
(12) Patent Application Publication
(10) Pub. No.: US 2006/0045006 A1
(43) Pub. Date: Mar. 2, 2006

(54) NODE PRESENCE CONFIRMATION METHOD AND APPARATUS

(75) Inventor: Ryuichiro Morioka, Tsurugashima-Shi, Saitama (JP)

Correspondence Address: DVA/PEC-IPD, 2355 MAIN STREET, SUITE 200, IRVINE, CA, 92614, US

(73) Assignee: PIONEER CORPORATION, Meguro-ku, Tokyo (JP)

(21) Appl. No.: 11/161,673

(22) Filed: Aug. 11, 2005

(30) Foreign Application Priority Data
Aug. 26, 2004 (JP) 2004-246514

(51) Int. Cl. H04J 3/14

(52) U.S. Cl. 370/221

(57) ABSTRACT

A circulation packet is circulated between nodes according to a circulation sequence list. The content of the circulation packet and whether transmission of the circulation packet to the node set as the next node in the circulation sequence list has failed is determined in the first node. When it is determined that execution of transmission of the circulation packet has failed, specifically, when loss of the node corresponding to the next node in the sequence is detected, the identification information of the corresponding node stored in the storage unit is deleted, a new circulation sequence list is generated in which the lost node is skipped in the circulation sequence, and the circulation packet is transmitted to the node that is newly set as the next node in the sequence. The present invention allows nodes to be efficiently confirmed in real time.

### CROSS REFERENCE TO RELATED APPLICATION

The present application claims priority under the Paris Convention to Japanese Patent Application No. 2004-246514, filed on Aug. 26, 2004.

### BACKGROUND OF THE INVENTION

1. Field of the Invention

The present invention relates to the technical field of node presence confirmation methods and apparatuses, which confirms the presence of a node in a network that has a plurality of nodes.

2. Description of the Related Art

Techniques have been proposed for circulating information between nodes in a network that has a plurality of nodes (see Japanese Patent Application, JP-A 2002-359711, for example).

According to the technique disclosed in JP-A 2002-359711, when circulation data received from a circulation origin apparatus are circulated in sequence to a circulation relay apparatus, there is no delaying of circulation since circulation data are transferred to another circulation relay apparatus set in advance as the transfer destination for instances of non-delivery when one circulation relay apparatus that is the transmission destination is unable to receive data.

Techniques for circulating data are also disclosed in Japanese Patent Applications, JP-A 7-44479 and JP-A 6-188953.

### SUMMARY OF THE INVENTION

However, the conventional techniques described above have the following drawbacks.

In a network, nodes frequently disappear from the network due to unexpected power losses, malfunctions in the control system, and other factors, for example. Accordingly, the nodes present in the network frequently change.

When data is circulated without a knowledge of which nodes are currently present on the network in such a situation, it becomes clear only in the circulation process, which nodes can communicate, and a heavy processing load is therefore involved in data transfer, particularly when the network has a large number of nodes. Specifically, it becomes difficult to perform data communication efficiently. Communication traffic increases and efficiency is severely reduced when presence confirmation is performed between each node mutually in one-to-one fashion in order to overcome such drawbacks.

The present invention was perfected in view of the foregoing drawbacks, and an object thereof is to provide a node presence confirmation method capable of efficient, real-time confirmation of the presence of a node on a network, and to provide a node presence confirmation apparatus.

The node presence confirmation method according to the invention for overcoming the abovementioned drawbacks comprises transmitting circulation information indicating the circulation sequence among a plurality of nodes participating in a network from one node in the plurality of nodes to another node that corresponds to the next node relative to the first node in the circulation sequence; determining whether the executed transmission has failed; updating the circulation information so that the other node is skipped in the circulation sequence when it is determined that the executed transmission has failed; and transmitting the updated circulation information from the first node to another node that corresponds to the next node relative to the first node in the circulation sequence according to the updated circulation information when it is determined that the executed transmission has failed.

The node presence confirmation method according to another embodiment of the invention for overcoming the above-mentioned drawbacks comprises transmitting circulation information indicating the circulation sequence among a plurality of nodes participating in a network from one node in the plurality of nodes to another node that corresponds to the next node relative to the first node in the circulation sequence; and determining that the other node has been lost from the network by determining whether the executed transmission has failed.

The node presence confirmation apparatus according to another embodiment of the invention for overcoming the abovementioned drawbacks is provided to one node among a plurality of nodes participating in a network, the node presence confirmation apparatus comprising a transmission mechanism, which transmits circulation information indicating the circulation sequence among the plurality of nodes to another node that corresponds to the next node relative to the first node in the circulation sequence; a determination mechanism, which determines whether the executed transmission has failed; and an updating mechanism, which updates the circulation information so that the other node is skipped in the circulation sequence when it is determined that the executed transmission has failed, wherein the transmission mechanism transmits the circulation information to another node that corresponds to the next node relative to the first node in the circulation sequence according to the updated circulation information is executed when it is determined that the executed transmission has failed.

The node presence confirmation apparatus according to another embodiment of the invention for overcoming the abovementioned drawbacks is provided to one node among a plurality of nodes participating in a network, the apparatus comprising a transmission mechanism, which transmits circulation information indicating the circulation sequence among the plurality of nodes to another node that corresponds to the next node relative to the first node in the circulation sequence; and a determination mechanism, which determines that the other node has been lost from the network by determining whether the executed transmission has failed.

### BRIEF DESCRIPTION OF THE DRAWINGS

FIG. 1 is a schematic diagram of the network system 10 according to a first working example of the present invention;

FIG. 2 is a block diagram of the node 200A according to a first working example of the present invention;

FIG. 3 is a schematic diagram of the circulation packet 300;

FIG. 4 is a flowchart of the presence confirmation processing executed by the CPU 211 in the node 200A;

FIG. 5 is a timing chart according to the presence confirmation processing;

FIG. 6 is a schematic diagram showing an embodiment of the circulation packet 300 and storage unit 230; and

FIG. 7 is a flowchart of the presence confirmation processing according to a second working example of the present invention.

### DESCRIPTION OF THE PREFERRED EMBODIMENTS

The first embodiment of the node presence confirmation method of the present invention is provided, which: transmits circulation information indicating the circulation sequence among a plurality of nodes participating in a network from one node in the plurality of nodes to another node that corresponds to the next node relative to the first node in the circulation sequence; determines whether the executed transmission has failed; updates the circulation information so that the other node is skipped in the circulation sequence when it is determined that the executed transmission has failed; and transmits the updated circulation information from the first node to another node that corresponds to the next node relative to the first node in the circulation sequence according to the updated circulation information when it is determined that the executed transmission has failed.

The term “node” in the present invention includes at least a component or the whole of a personal computer, server, work station, or other computer or peripheral device thereof; a television, television tuner, video or DVD recorder, or other AV device; a fax machine or other communication device; or the like, and is used to refer to a device that can be part of a network.

By the operation according to the first embodiment of the node presence confirmation method of the present invention, circulation information indicating the circulation sequence among a plurality of nodes participating in a network is transmitted from a first node to the node that corresponds to the next node relative to the first node in the circulation sequence. Specifically, the circulation information is circulated according to the circulation sequence continually or at preset time intervals among a plurality of nodes in a network.

When transmission of this circulation information has been executed, it is determined in the first node whether execution of the transmission has failed. When it is determined that execution of transmission has failed, the node that corresponds to the next node in this circulation sequence is considered lost. A transmission error or the like generated, for example, during transmission of the circulation information is detected as a transmission. In this case, the determination that transmission has failed to execute may be made when execution of transmission fails once, or when a predetermined number of transmissions have failed.

The term “node loss” used in the present invention indicates a state in which a node is unable to communicate, and includes, for example, cases in which the power source fails or is turned off, and a node is physically removed from the network, and cases in which the node is physically present in the network but is unresponsive due to a malfunction or the like of a control system for performing upper-level control of the node, for example.

When it is determined that execution of transmission has failed; specifically, when the loss of a node is detected, the circulation information is updated into circulation information whereby the node in which execution of transmission has failed; specifically, the node set as the next node from the first node in the circulation sequence, is skipped in the circulation sequence.

When the circulation information is updated in this manner, transmission of the updated circulation information from the first node to another node that corresponds to the next node relative to the first node in the circulation sequence according to the updated circulation information is re-executed.

When failure of transmission to the node corresponding to the next node is not detected, the circulation information is circulated between the nodes according to the circulation sequence with no change applied to the circulation sequence in the circulation information.

Thus, according to the first embodiment of the node presence confirmation method of the present invention, the circulation information is updated when the first node detects that the node corresponding to the next node in the circulation sequence has been lost. The node included in the circulation sequence in this updated circulation information specifically becomes a present node. Accordingly, information about the currently present nodes can be confirmed in real time in another node. Since the circulation information is information that is circulated in order to confirm the presence of a node, the processing load is extremely low. Confirmation of a present node can therefore be executed with extremely high efficiency.

In an aspect of the first embodiment of the node presence confirmation method of the present invention, the circulation information comprises presence information indicating the presence of the plurality of nodes, and sequence information indicating the circulation sequence of the plurality of nodes in correlation with the presence information, wherein the presence information and sequence information are each updated.

In this aspect, since the circulation information comprises presence information indicating the presence of a node, and sequence information indicating the circulation sequence, and both types of information are updated, it becomes possible for confirmation of a node present on the network to be efficiently executed in another node.

The term “presence information” used in the present invention is in no way limited insofar as it can distinguish nodes from each other, for example. This information may, for example, simply be an identifier assigned to each node, or may, for example, include a portion or all of connection setting information such as a network address that is necessary for communication with the nodes on the network. This presence information may also be any information that is incidental to these types of information.

In another aspect of the first embodiment of the node presence confirmation method of the present invention, the first node has a storage mechanism, which stores presence information indicating the presence of the plurality of nodes; and the circulation information is updated and the stored presence information is further updated so as to indicate the absence of the other node when it is determined that the executed transmission has failed.

In this aspect, the first node is provided with storage mechanism, which stores the presence information of the plurality of nodes participating in the network, and the presence information stored in this storage mechanism is updated along with the circulation information. In this regard, since the presence information relating to the lost node is updated to reflect the absence thereof, it becomes possible for the latest presence information for that point in time to be stored in the first node.

In another aspect of the first embodiment of the node presence confirmation method of the present invention, loss information indicating that the other node has been lost from the network is transmitted together with the circulation information when it is determined that the executed transmission has failed.

In this aspect, since loss information indicating that transmission has failed to execute is transmitted as loss information together with the circulation information the loss of the other node can be confirmed extremely easily in another node.

In another aspect of the first embodiment of the node presence confirmation method of the present invention, loss information is transmitted, indicating that the other node has been lost from the network from the first node to a node other than the first node and the other node among the plurality of nodes when it is determined that the executed transmission has failed.

In this aspect, the loss information indicating the loss of the other node is transmitted to a node other than the first node and the other node by a pathway other than that of the circulation information when it is determined that the transmission executed from the first node to the other node has failed. For example, a mode referred to as a broadcast, which designates, for example, an unspecified large number of nodes present in a network, or a mode referred to as a multicast, which designates a specific number of nodes, is employed as the mode for transmitting the loss information. According to this aspect, since the other node is immediately notified when the loss of a node is detected, the ability to confirm the present nodes in real time increases even further.

In an aspect of the first embodiment of the node presence confirmation method provided with a storage mechanism, the loss of a node is detected, based on a relative comparison between the presence information included in the circulation information and the presence information stored in the storage mechanism.

In this aspect, the loss of a node is detected based on a relative comparison between the presence information included in the circulation information and the presence information stored in the storage mechanism. For example, a node that is included in the presence information stored in the storage mechanism and not in the presence information included in the circulation information is a node for which a loss was detected in any of the nodes in the process in which the circulation information is circulated. It therefore becomes possible to simplify confirmation of the nodes present on the network by this type of relative comparison. This confirmation is also efficient because loss information indicating the loss of a node need not be included in the circulation information. When the loss of a node is detected based on this type of relative comparison, the presence information stored in the storage mechanism may be updated so as to indicate the absence of this node, for example. The second embodiment of the node presence confirmation method of the present invention is provided, which transmits circulation information indicating the circulation sequence among a plurality of nodes participating in a network from one node in the plurality of nodes to another node that corresponds to the next node relative to the first node in the circulation sequence; and determines that the other node has been lost from the network by determining whether the executed transmission has failed.

During operation according to the second embodiment of the node presence confirmation method of the present invention, the circulation information is transmitted from the first node to another node that corresponds to the next node in the circulation sequence the same as described above. It is determined in the first node by the operation in the determination mechanism whether the other node has been lost from the network by determining whether execution of this transmission has failed.

The second embodiment thus differs from the first embodiment in that it does not include an operation for updating the circulation information. The loss of a node can be detected with such an aspect as well.

In an aspect of the second embodiment of the node presence confirmation method according to the present invention, loss information is transmitted, indicating that the other node has been lost from the network from the first node to a node other than the first node and the other node among the plurality of nodes when it is determined that the other node has been lost from the network.

In this aspect, transmission of a loss notification indicating that another node has been lost from the network to another node other than the node that is determined to have been lost is executed in the first node when it is determined that another node has been lost. The loss of a node can therefore be immediately confirmed in a node to which transmission is executed.

In another aspect of the embodiments of the node presence confirmation method according to the present invention described above, acknowledgement information is transmitted, indicating that the circulation information has been received to the first node from the other node that corresponds to the next node relative to the first node in the circulation sequence, and a failure of the executed transmission is further determined based on whether the acknowledgement information has been received.

In this aspect, acknowledgement information is transmitted from another node corresponding to the next node in the circulation sequence from the first. In the first node, whether execution of transmission to the other node has failed is determined based on whether the acknowledgement information has been received.

When the acknowledgement information is not received, there is a high probability that this other node that corresponds to the next node in the sequence has been lost. It therefore becomes possible for the loss of a node to be detected even more reliably. In this case, when the acknowledgement information is not received within a certain period of time, for example, the loss of another node corresponding to the next node in the circulation information is detected.

In an aspect in which this type of acknowledgement information is provided, the acknowledgement information may be executed after execution of the initial transmission.

For example, when another node corresponding to the next node in the sequence that has received the circulation information is lost during the time from when the acknowledgement information is transmitted to the first node until the circulation information is transmitted to the node corresponding to the next node in the circulation sequence, it is possible for the circulation information to be lost along with the lost node.

In this aspect, circulation delay can be prevented and reliability can be enhanced even further since the acknowledgement information is transmitted after the circulation information has been transmitted to the node corresponding to the next node in the circulation sequence. The first embodiment of the node presence confirmation apparatus according to the present invention is a node presence confirmation apparatus provided to one node among a plurality of nodes participating in a network, the apparatus comprising a transmission mechanism, which transmits circulation information indicating the circulation sequence among the plurality of nodes to another node that corresponds to the next node relative to the first node in the circulation sequence; a determination mechanism, which determines whether the executed transmission has failed; and an updating mechanism, which updates the circulation information so that the other node is skipped in the circulation sequence when it is determined that the executed transmission has failed, wherein the transmission mechanism transmits the circulation information to another node that corresponds to the next node relative to the first node in the circulation sequence according to the updated circulation information when it is determined that the executed transmission has failed.

In the first embodiment of the node presence confirmation apparatus according to the present invention, the various mechanisms perform the various steps in the first embodiment of the node presence confirmation method according to the present invention described above, whereby it becomes possible for efficient confirmation of present nodes to be performed in real time. The second embodiment of the node presence confirmation apparatus according to the present invention is a node presence confirmation apparatus provided to one node among a plurality of nodes participating in a network, the apparatus comprising transmission mechanisms, which transmit circulation information indicating the circulation sequence among the plurality of nodes to another node that corresponds to the next node relative to the first node in the circulation sequence; and determination mechanisms, which determine that the other node has been lost from the network by determining whether the executed transmission has failed.

In the second embodiment of the node presence confirmation apparatus according to the present invention, the various mechanisms perform the various steps in the second embodiment of the node presence confirmation method according to the present invention described above, whereby it becomes possible for efficient confirmation of present nodes to be performed in real time.

As described above, since the first embodiment of the node presence confirmation method has a first transmission block, a determination block, an updating block, and a second transmission block, efficient confirmation of present nodes can be performed in real time. Since the second embodiment of the node presence confirmation method has a first transmission block and a determination block, efficient confirmation of present nodes can be performed in real time. Since the first embodiment of the node presence confirmation apparatus is equipped with transmission mechanisms, determination mechanisms, and updating mechanisms, efficient confirmation of present nodes can be performed in real time. Since the first embodiment of the node presence confirmation apparatus is equipped with transmission mechanisms and determination mechanisms, efficient confirmation of present nodes can be performed in real time.

These and other effects and advantages of the present invention will become apparent from the working examples described hereinafter.

Working examples of the present invention will be described hereinafter with reference to the drawings.

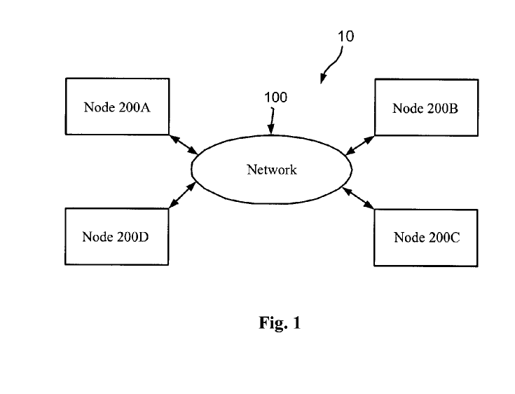

The environment in which a node provided with presence confirmation capability according to a first working example of the present invention is mounted will first be described with reference to FIG. 1.

In FIG. 1, the network system 10 is a system composed of nodes 200A, 200B, 200C, and 200D present in a network 100.

The network 100 is a wired LAN (Local Area Network) such as an Ethernet (registered trademark), for example, and is an example of the “network” of the present invention configured so as to enable a plurality of nodes to communicate with each other.

The form of the network 100 is not limited to a wired LAN. For example, the network may be a wireless LAN such as one that is defined according to IEEE 802.11, or may be an internet as defined according to an internet protocol. The network may also have a specification (IEEE 1394, for example) whereby the loss of a node can be automatically detected when a node is lost.

The nodes 200A, 200B, 200C, and 200D are personal computers, for example, and are configured so as to be capable of communication with each other via the network 100. Each node also functions as an example of the “node presence confirmation apparatus” according to the present invention. In the present working example, each node has the same basic structure. However, the form of the nodes in the present invention is in no way limited insofar as the nodes are capable of communicating with each other via a network, and the nodes may be personal computers, servers, work stations, or other computers or peripheral devices thereof; televisions, television tuners, video or DVD recorders, or other AV devices; or fax machines or other communication devices.

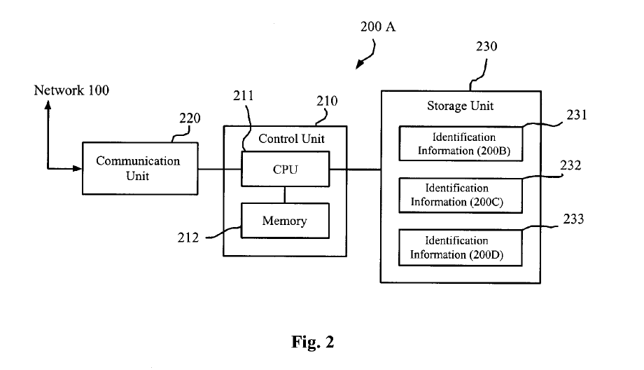

The structure of the nodes will next be described with reference to FIG. 2. FIG. 2 is a block diagram of the node 200A.

In FIG. 2, the node 200A is provided with a control unit 210, a communication unit 220, and a storage unit 230.

The control unit 210 is provided with a CPU (Central Processing Unit) 211 and memory 212. The CPU 211 is a unit for controlling the components of the node 200A described hereinafter, and is configured to function as an example of both the “determination mechanisms” and the “updating mechanisms” according to the present invention.

The memory 212 is configured so as to be capable of temporarily storing the data generated during execution of the presence confirmation processing (described hereinafter) by the CPU 211.

The communication unit 220 is configured so as to be capable of transmitting or receiving a circulation packet 300 and the acknowledgement packet described hereinafter via the network 100 during operation of the node 200A, and functions as an example of the “transmission mechanisms” according to the present invention.

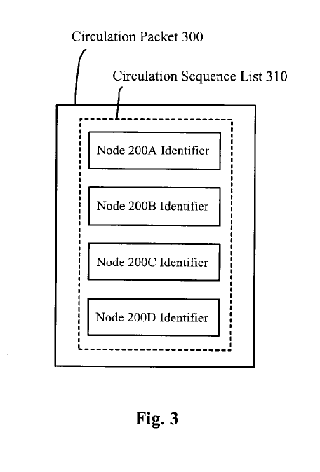

The circulation packet 300 will be described in detail with reference to FIG. 3. FIG. 3 is a schematic diagram of the circulation packet 300.

In FIG. 3, the circulation packet 300 is a data packet having a circulation sequence list 310, which circulates the circulation packet 300 between the nodes present in the network 100, and is an example of the “circulation information” according to the present invention.

The circulation sequence list 310 is a list having the identifier of each node in the order in which the circulation packet 300 is circulated, and is configured so that the previous and subsequent nodes can each be confirmed based on the corresponding node's identifier in the nodes that have received the circulation packet 300. In the present working example, the circulation packet 300 is circulated in the following order: node 200A, node 200B, node 200C, node 200D, and a circulation packet is again circulated to the node 200A subsequent to circulation to node 200D.

The circulation sequence list 310 in the circulation packet 300 may also be configured to accompany a number or the like indicating the circulation sequence before the identifier, for example. When such information (specifically, an example of the “sequence information” according to the present invention) for indicating the circulation sequence is included, the identifiers may not necessarily be arranged in the circulation sequence in the circulation sequence list 310. The circulation packet 300 is configured so as to have only an identifier in the present working example, but information (specifically, an example of the “presence information” according to the present invention) that is equivalent to identification information stored in the storage unit 230 described hereinafter may also be included therein.

When a new node is added in the network 100, notification of this addition is automatically communicated by broadcast from the added node. The processing for adding this newly added node to the circulation sequence list 310 is performed at that time in the node that possesses the circulation packet 300, but description of this processing is omitted in the present working example in order to prevent the description from becoming too complex.

Returning to FIG. 2, the storage unit 230 is a hard disk or other rewritable storage medium, for example, and is an example of the “storage mechanisms” according to the present invention. The identification information (an example of the “presence information” according to the present invention) of another node present in the network 100 is stored in the storage unit 230.

Identification information 231, identification information 232, and identification information 233 are stored in the storage unit 230. The items of identification information correspond to the node 200B, the node 200C, and the node 200D, respectively, and include the properties of each node, connection setting information necessary for communicating with each node, and the like. The CPU 211 references the identification information of the corresponding node from the storage unit 230 when performing communication with the nodes.

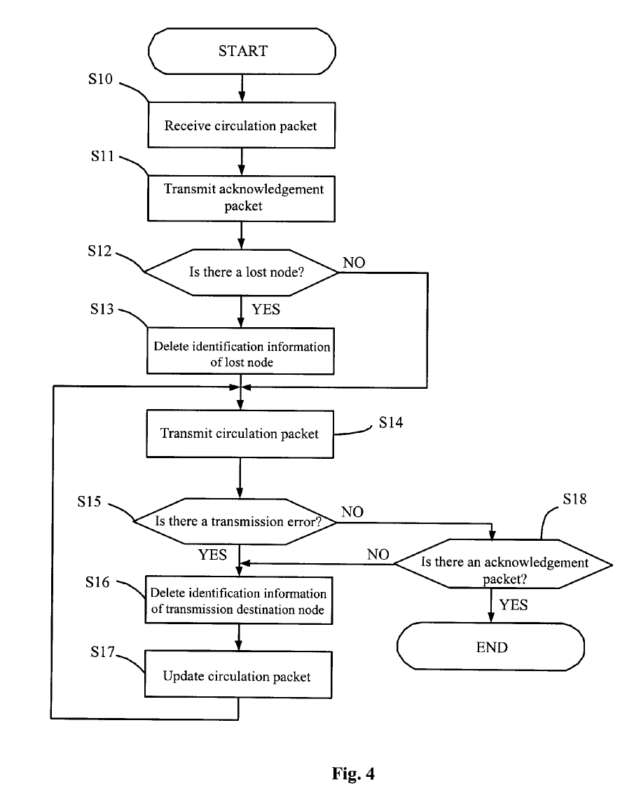

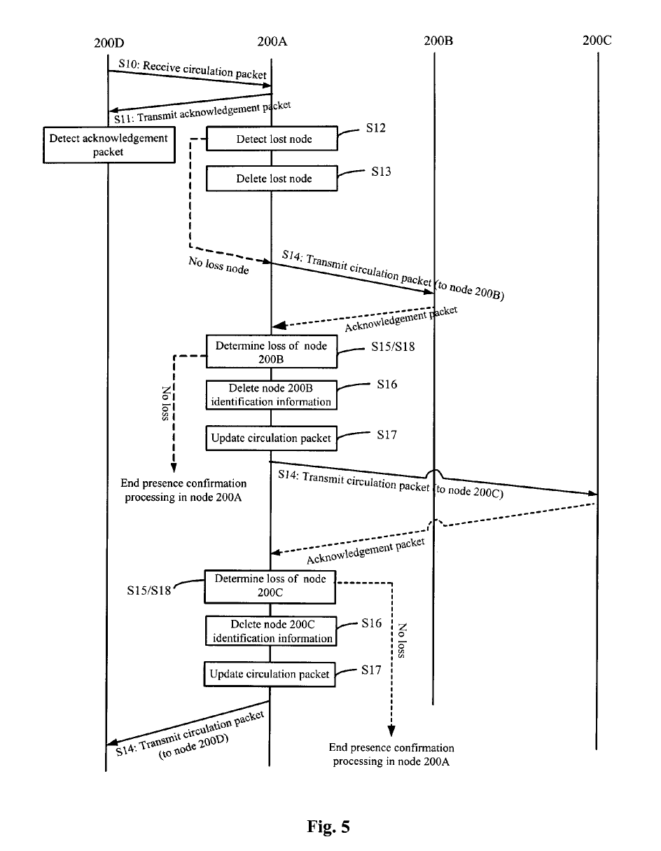

As previously mentioned, when notification of the participation of a new node in the network is issued, the identification information of that node is also transmitted and stored in the storage units 230 of the nodes. When loss of a node is detected by the presence confirmation processing described hereinafter, the identification information of that node is deleted from the storage unit 230. Specifically, nodes for which identification information is stored in the storage unit 230 are nodes that are confirmed as being currently present. The operation of the node 200A having the abovementioned configuration will next be described with reference to FIGS. 4 and 5. FIG. 4 herein is a flowchart of the presence confirmation processing executed by the CPU 211 in the node 200A, and FIG. 5 is a timing chart thereof. FIGS. 4 and 5 are used jointly in the description below.

First, the circulation packet 300 is received at a certain time in the node 200A (step S10). The circulation packet 300 thus received is temporarily stored in the memory 212. The CPU 211 references the memory 212, detects from the circulation sequence list 310 included in the circulation packet 300 that the node that transmitted this circulation packet 300 is the node 200D, and transmits an acknowledgement packet to the node 200D (step S11). At this time, the identification information 233 of the node 200D is referenced from the storage unit 230 based on the identifier of the node 200D ascertained from the circulation sequence list 310, and an acknowledgement packet is transmitted from the communication unit 220.

The acknowledgement packet herein is a packet that includes the identifier of the receiving node transmitted from the node (node 200A in this case) that received the circulation packet 300 to the transmission source node (node 200D in this case). Step S11 is an example of the “acknowledgement information transmission block” according to the present invention.

When the circulation packet 300 is received, the CPU 211 determines whether a node has been lost based on the contents of the circulation packet 300 (step S12). Specifically, the CPU 211 detects whether there is a node that is not included in the circulation sequence list 310 among the nodes stored in the storage unit 230. Step S12 is an example of the “lost node detection block” according to the present invention.

In the present working example, since the circulation sequence list has only identifiers, and the identification information is what is stored in the storage unit 230, the identifiers and the identification information are technically non-equivalent. However, there is a one-to-one correspondence between the identifier and the identification information, and a lost node can be detected based on this type of relative comparison. In this sense, the term “presence information” according to the present invention does not require that the form stored in the storage unit 230 necessarily be equivalent to the form included in the circulation information.

In the present working example, a lost node is detected based on this type of relative comparison between the circulation sequence list and the content stored in the storage unit 230, but when information is stored in the circulation sequence list 310 that is equivalent to the identification information stored in the storage unit 230, for example, the content stored in the storage unit 230 may be substituted with the circulation sequence list 310 included in the circulation packet 300 when the circulation packet 300 is received. In such a case, efficiency is enhanced because the processing associated with comparison becomes unnecessary.

When a lost node is not detected (step S12: NO), the CPU 211 advances the processing to step S14. When a lost node is detected (step S12: YES), the CPU 211 deletes the identification information of the lost node from the storage unit 230 (step S13).

In step S13, the identification information may not necessarily be deleted, and may be stored in the storage unit 230 along with information indicating the absence of the node.

When a lost node is not detected in step S12, or when step S13 is executed, step S14 is executed. The circulation packet 300 is transmitted in step S14. In the present working example, description will be continued with the assumption that a lost node was not detected in step S12 (specifically, supposing that all of the nodes are present at this time).

When the circulation packet 300 is transmitted, the CPU 211 detects that the node corresponding to the next node in the circulation sequence list 310 is node 200B, references the identification information 231 of the node 200B from the storage unit 230, and transmits the result from the communication unit 220. Step S14 is an example of the “first transmission block” according to the present invention.

When the circulation packet 300 is transmitted to the node 200B, the CPU 211 determines the presence of a transmission error (step S15). When a transmission error is not detected (step S15: NO), the CPU 211 then determines the presence of an acknowledgement packet from the node 200B (step S18). As previously mentioned, transmission of an acknowledgement packet to the transmission source, specifically, to the node corresponding to the previous node in the circulation sequence list, is executed by the node that has received the circulation packet 300 in the present working example. Accordingly, when a transmission error is not detected, an acknowledgement packet is usually transmitted from the node 200B and stored in the memory 212 via the communication unit 220.

When an acknowledgement packet is not received for whatever reason (step S18: NO), or when a transmission error is detected (step S15: YES), the CPU 211 determines that the node 200B that is the transmission destination has been lost, and deletes the identification information 231 of the node 200B from the storage unit 230 (step S16). The processing in step S15 and step S18 is an example of the “determination block” according to the present invention. In the present working example, a determination that an acknowledgement packet is not received is made when no acknowledgement packet is received during a certain waiting period after the transmission of the circulation packet 300 in step S14. The waiting period is measured using a timer included in the CPU 211, but the set value of the waiting period may be set in advance to a value that includes an appropriate margin, or may be set to an appropriate value in view of the communication traffic conditions in each case. Deletion of the identification information 231 in step S16 is an example of the updating step according to the present invention.

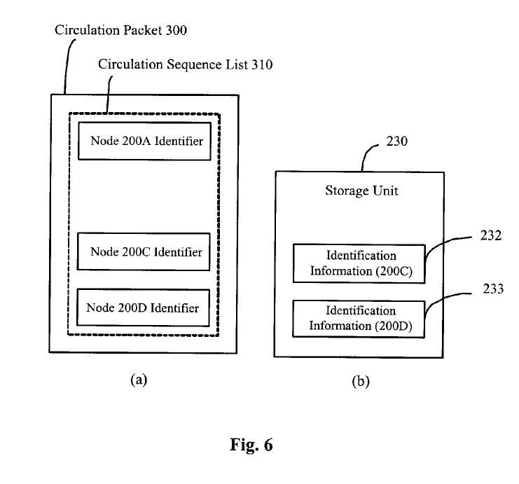

When the identification information 231 of the node 200B that corresponds to the next node is deleted, the circulation packet 300 is updated (step S17). The structure of the circulation packet 300 and the storage unit 230 in this case will be described herein with reference to FIG. 6. FIG. 6 has schematic diagrams of the updated circulation packet 300, and of the storage unit 230 from which the identification information has been deleted. Step S17 is another example of the “updating block” according to the present invention.

The circulation packet 300 is shown in FIG. 6(a). In the updated circulation packet 300, the loss of the node 200B is reflected in the circulation sequence list 310, and the identifier of the node 200B is deleted. The storage unit 230 is shown in FIG. 6(b). The identification information 231 of the node 200B is deleted from the storage unit 230. Updating of the circulation packet 300 is not limited to the embodiment described herein. For example, insofar as the node whose loss was detected is skipped in the circulation sequence, or insofar as another node is capable of confirming that the node whose loss was detected has been skipped from the circulation sequence, the identifier of the node whose loss was detected need not be deleted from the circulation sequence list 310.

When the circulation packet 300 is updated, the circulation packet 300 is again transmitted (step S14). At this time, the circulation packet 300 is transmitted to the node 200C newly set as the next node in the sequence from node 200A according to the circulation sequence list 310 of the updated circulation packet 300. Updating and transmission of the circulation packet is repeated thereafter by step S18 until the acknowledgement packet transmitted from the node corresponding to the next node in the sequence is received. For example, the circulation packet 300 is transmitted to node 200C when loss of node 200B is detected, and the circulation packet 300 is transmitted to node 200D when loss of node 200C is detected.

Lastly, when an acknowledgement packet transmitted from another node that corresponds to the next node in the sequence is received (step S18: YES), the presence confirmation processing of the present working example is ended.

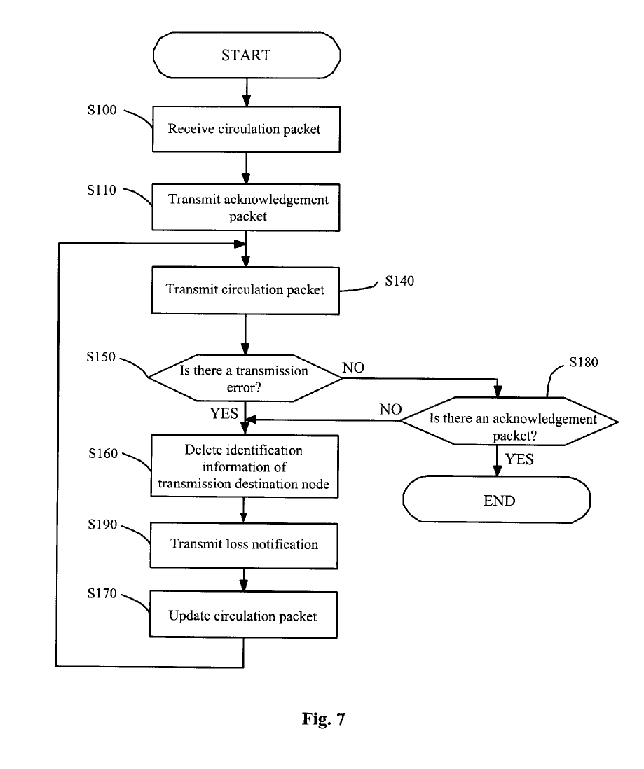

By the operation described above, only the identification information of the nodes that are currently present is stored in the storage unit 230 of the first node according to the present working example, and it becomes possible for efficient confirmation of nodes present in the network 100 to be performed in the first node in real time. Loss of a node other than the node set to be next in the sequence was performed by referencing of the circulation packet 300 in the first working example described above, but the time required for circulation of the circulation packet 300 increases when the number of nodes present in the network 100 increases, and a time lag can occur until loss of the node is shared among the nodes. A second working example of the present invention that is capable of overcoming this type of drawback is described herein with reference to FIG. 7. FIG. 7 is a flowchart of the presence confirmation processing according to a second working example of the present invention. The structure of the nodes according to the second working example is the same as in the first working example, and description thereof is omitted.

In FIG. 7, the presence confirmation processing according to the second working example further has a step, which notifies a node other than the node whose loss has been detected that loss of the node corresponding to the next node in the sequence has been detected, and differs from the first working example in that the step, which detects the loss of a node based on the relative comparison between the content of the circulation packet 300 and the stored content of the storage unit 230 is omitted.

Specifically, when the acknowledgement packet is transmitted to the transmission source node in step S110 (after receiving the circulation packet in step S100), the CPU 211 transmits the circulation packet 300 thus received to the node 200B corresponding to the next node in the sequence (step S140). When loss of the node corresponding to the next node in the sequence is detected by step S150 or S180, the identification information of that node is deleted from the storage unit 230 by the processing in step S160, after which a loss notification is transmitted (step S190).

This loss notification is a transmitted data packet that includes the identifier of the lost node, and step S190 is an example of the “third transmission block” according to the present invention, after which the circulation packet is updated at step S170. Loss notification is transmitted as a data packet in a format that can be received by all of the nodes currently present in the network by a broadcast communication. The identifier included in the loss notification and stored in the memory 212 via the communication unit 220 is referenced in the nodes that have received the loss notification, and the identification information of the node that corresponds to the identifier is deleted from the storage unit 230. The processing associated with this deletion can be appropriately executed by interrupt processing.

In the second working example as described above, since another node is immediately notified when loss of the node corresponding to the next node in the sequence is detected by the first node by transmission of the circulation packet 300, the ability to confirm the present nodes in real time increases even further.

In the working examples described above, an acknowledgement packet indicating that the circulation packet 300 was received is executed before the circulation packet 300 is transmitted to the node corresponding to the next node in the sequence. In this case, when a node is lost immediately after the acknowledgement packet is transmitted to the transmission source node, the circulation packet 300 may not be transmitted to any of the nodes, and it may be impossible for the loss of the node to be detected in another node. In order to prepare for such a situation, transmission of the acknowledgement packet may be performed after transmission of the circulation packet 300 to the node corresponding to the next node in the sequence is completed. In this case, the waiting period for detecting whether the acknowledgement packet has been received may be set to an appropriate value (specifically, a time that is longer than that of the working example described above).

The present invention is in no way limited by the working examples described above, and may be appropriately modified within a range that does not depart from that of the essence or idea of the invention as understood from the claims and the specification as a whole. Such modified node presence confirmation methods and node presence confirmation apparatuses are also included in the technological scope of the present invention.

What is claimed is:

1. A node presence confirmation method comprising:
transmitting circulation information indicating a circulation sequence among a plurality of nodes participating in a network from one node in the plurality of nodes to another node that corresponds to a next node relative to a first node in the circulation sequence;
determining whether an executed transmission has failed;
updating the circulation information so that said another node is skipped in the circulation sequence when it is determined that the executed transmission has failed; and
transmitting the updated circulation information from the first node to a second node that corresponds to a new next node relative to the first node in the circulation sequence according to the updated circulation information when it is determined that the executed transmission has failed.

2. The node presence confirmation method according to claim 1, the circulation information comprising:
presence information indicating the presence of the plurality of nodes; and
sequence information indicating the circulation sequence of the plurality of nodes in correlation with the presence information, wherein the presence information and sequence information are each updated.

3. The node presence confirmation method according to claim 1, wherein the first node has a storage mechanism, which stores presence information indicating the presence of the plurality of nodes; and the circulation information is updated and the stored presence information is further updated so as to indicate the absence of said another node when it is determined that the executed transmission has failed.

4. The node presence confirmation method according to claim 1, wherein loss information indicating that said another node has been lost from the network is transmitted together with the circulation information when it is determined that the executed transmission has failed.

5. The node presence confirmation method according to claim 1, further comprising transmitting loss information indicating that said another node has been lost from the network from the first node to a node other than the first node and said another node among the plurality of nodes when it is determined that the executed transmission has failed.

6. The node presence confirmation method according to claim 3, further comprising detecting the loss of a node based on a relative comparison between the presence information included in the circulation information and the presence information stored in the storage mechanism.

7. A node presence confirmation method comprising:
transmitting circulation information indicating a circulation sequence among a plurality of nodes participating in a network from one node in the plurality of nodes to another node that corresponds to a next node relative to a first node in the circulation sequence; and
determining that said another node has been lost from the network by determining whether an executed transmission has failed.

8. The node presence confirmation method according to claim 7, further comprising transmitting loss information indicating that said another node has been lost from the network from the first node to a node other than the first node and said another node among the plurality of nodes when it is determined that said another node has been lost from the network.

9. The node presence confirmation method according to claim 7, further comprising transmitting acknowledgement information indicating that the circulation information has been received to the first node from said another node that corresponds to the next node relative to the first node in the circulation sequence; wherein a failure of the executed transmission is further determined based on whether the acknowledgement information has been received.

10. The node presence confirmation method according to claim 9, further comprising executing the transmission of said acknowledgement information after the transmission of said circulation information.

11. A node presence confirmation apparatus provided to one node among a plurality of nodes participating in a network, said node presence confirmation apparatus comprising:
a transmission mechanism, which transmits circulation information indicating a circulation sequence among the plurality of nodes to another node that corresponds to a next node relative to a first node in the circulation sequence;
a determination mechanism, which determines whether an executed transmission has failed; and
an updating mechanism, which updates the circulation information so that said another node is skipped in the circulation sequence when it is determined that the executed transmission has failed, wherein the transmission mechanism transmits the circulation information to a second node that corresponds to a new next node relative to the first node in the circulation sequence according to the updated circulation information when it is determined that the executed transmission has failed.

12. A node presence confirmation apparatus provided to one node among a plurality of nodes participating in a network, said node presence confirmation apparatus comprising:
a transmission mechanism, which transmits circulation information indicating a circulation sequence among the plurality of nodes to another node that corresponds to a next node relative to a first node in the circulation sequence; and
a determination mechanism, which determines that said another node has been lost from the network by determining whether an executed transmission has failed.
